(19) United States
(12) Patent Application Publication
(10) Pub. No.: US 2025/0037495 A1
(43) Pub. Date: Jan. 30, 2025

(54) PERSON INTENTION REASONING METHOD, APPARATUS AND DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Xiaochuan LI, Suzhou, Jiangsu (CN); Zhenhua GUO, Suzhou, Jiangsu (CN); Yaqian ZHAO, Suzhou, Jiangsu (CN); Rengang LI, Suzhou, Jiangsu (CN); Baoyu FAN, Suzhou, Jiangsu (CN)

(21) Appl. No.: 18/716,483

(22) PCT Filed: Sep. 23, 2022
(86) PCT No.: PCT/CN2022/121131

§ 371 Date: Jun. 4, 2024

(30) Foreign Application Priority Data
Apr. 28, 2022 (CN) 202210455168.6

(51) Int. Cl. G06V 40/10; G06T 3/4046; G06V 10/25; G06V 10/26; G06V 10/774; G06V 10/80; G06V 10/82

(52) U.S. Cl. CPC G06V 40/10; G06T 3/4046; G06V 10/25; G06V 10/26; G06V 10/774; G06V 10/806; G06V 10/82; G06V 2201/07

(57) ABSTRACT

The person intention reasoning method includes: performing object detection on a to-be-reasoned image to obtain an object detection result; determining that an image portion corresponding to a detection bounding box of each person in the to-be-reasoned image is a to-be-reasoned sub-image of the corresponding person respectively, and acquiring a joint feature and an occlusion probability of a joint of the corresponding person; performing prediction and analysis on the joint feature of corresponding joint based on the occlusion probability to obtain a corresponding prediction feature, and performing correction based on the joint feature and the prediction feature of the joint of the corresponding person to obtain a corresponding correction feature; and performing person intention reasoning by using the object detection result and the correction feature of the joint of the corresponding person to obtain a corresponding person intention reasoning result.

### CROSS-REFERENCE TO RELATED APPLICATION

This application claims priority to Chinese Patent Application No. 202210455168.6, filed on Apr. 28, 2022 in China National Intellectual Property Administration and entitled “Person Intention Reasoning Method, Apparatus and Device, and Storage Medium”, which is hereby incorporated by reference in its entirety.

### FIELD

The present application relates to the technical field of visual commonsense reasoning, and in particular, to a person intention reasoning method, apparatus and device, and a storage medium.

### BACKGROUND

In recent years, multimodality has become an emerging research direction in the field of artificial intelligence, and visual commonsense reasoning (VCR) is an important research branch in the field of multimodality, which aims at inferring the correctness of text descriptions through visual information. As shown in FIG. 1, researchers input images and texts to enable a model to infer an intention of a target task, thus enabling the model to have the ability of reasoning according to data of both image and text modalities.

At present, a mainstream method for solving VCR tasks is to input visual features and text features into a transformer structure together to perform modality fusion. However, in the actual research and development process, the inventor found that since the existing algorithms mainly rely on results of a target detection network in an extraction method of visual features, and most of the existing target detection networks are based on Visual Genome or COCO to complete the training, the granularity of human features is coarse, which leads to lower accuracy of the person intention reasoning.

### SUMMARY

The present application provides the following technical solutions:

A person intention reasoning method includes:
performing target detection on a to-be-reasoned image to obtain a corresponding target detection result;
determining a detection bounding box of each person in the to-be-reasoned image based on the target detection result, determining that an image portion corresponding to each detection bounding box in the to-be-reasoned image is a to-be-reasoned sub-image of a corresponding person respectively, and acquiring a joint feature and an occlusion probability of a joint of the corresponding person in each to-be-reasoned sub-image;
performing prediction and analysis on the joint feature of corresponding joint based on the occlusion probability to obtain a corresponding prediction feature, and performing correction based on the joint feature and prediction feature of the joint of the corresponding person in each to-be-reasoned sub-image to obtain a correction feature of the joint of the corresponding person in each to-be-reasoned sub-image; and
performing person intention reasoning by using the target detection result and the correction feature of the joint of the corresponding person in each to-be-reasoned sub-image to obtain a corresponding person intention reasoning result.

In an embodiment, the performing prediction and analysis on the joint feature of the corresponding joint based on the occlusion probability to obtain the corresponding prediction feature includes:
taking an arbitrary to-be-reasoned sub-image as a current sub-image, and performing coding fusion on the joint feature and corresponding occlusion probability of each joint in the current sub-image to obtain corresponding fused feature information; and
inputting the fused feature information of the current sub-image into an occluded joint prediction network to obtain a prediction feature of each joint in the current sub-image outputted by the occluded joint prediction network, wherein the occluded joint prediction network is obtained by pre-training based on a plurality of pieces of the fused feature information of a known prediction feature.

In an embodiment, the performing coding fusion on the joint feature and corresponding occlusion probability of each joint in the current sub-image to obtain corresponding fused feature information includes:
splicing the joint feature of the current sub-image and the occlusion probability of the current sub-image directly into a corresponding multi-dimensional vector as the fused feature information of the current sub-image.

In an embodiment, the performing coding fusion on the joint feature and corresponding occlusion probability of each joint in the current sub-image to obtain corresponding fused feature information includes:
extending the occlusion probability of the current sub-image into a d-dimensional sub-probability, and adding the d-dimensional sub-probability to a d-dimensional joint feature of the current sub-image in one-to-one correspondence to obtain the fused feature information of the current sub-image.

In an embodiment, the adding the d-dimensional sub-probability to the d-dimensional joint feature of the current sub-image in one-to-one correspondence to obtain the fused feature information of the current sub-image includes:
splicing the d-dimensional joint feature and one-dimensional occlusion sub-probability p into a (d+1)-dimensional vector to obtain the fused feature information of the current sub-image.

In an embodiment, the adding the d-dimensional sub-probability to the d-dimensional joint feature of the current sub-image in one-to-one correspondence to obtain the fused feature information of the current sub-image includes:
extending an occlusion sub-probability p into d dimensions, and then adding to the d-dimensional joint feature of the current sub-image in one-to-one correspondence to obtain the fused feature information of the current sub-image.

In an embodiment, the method further includes:
acquiring a plurality of images as training images respectively, wherein each training image includes a single person;
acquiring fused feature information and a corresponding prediction feature of each training image; and
inputting the fused feature information and corresponding prediction feature of each training image into a graph convolutional network, and training the graph convolutional network, wherein the trained graph convolutional network is the occluded joint prediction network.

In an embodiment, the acquiring the joint feature of the joint of the corresponding person in each to-be-reasoned sub-image includes:
taking an arbitrary to-be-reasoned sub-image as a current sub-image, and compressing the current sub-image into a multi-dimensional vector by using a convolutional neural network, wherein the multi-dimensional vector includes specified data obtained by compressing a length and a width of the current sub-image respectively according to a downsampling multiple of the convolutional neural network; and
obtaining average pooling of the specified data in the multi-dimensional vector of the current sub-image to obtain a vector of the joint feature of each joint in the current sub-image.

In an embodiment, compressing the current sub-image into the multi-dimensional vector by using the convolutional neural network includes:
abstracting the current sub-image into a plurality of joint, and for an extracted image portion of the current sub-image corresponding to each detection bounding box, compressing, by the convolutional neural network, an arbitrary image portion in each image portion into a multi-dimensional vector of [h//s, w//s, N],
wherein, s represents the downsampling multiple of the convolutional neural network, // represents a compression operation using the convolutional neural network, N represents a total number of joints contained in the current sub-image, h and w represent the length and the width of the arbitrary image portion respectively, and h//s and w//s are both called the specified data.

In an embodiment, the obtaining average pooling of the specified data in the multi-dimensional vector of the current sub-image to obtain the vector of the joint feature of each joint in the current sub-image includes:
obtaining the average pooling of the specified data of preceding two dimensional vectors in the multi-dimensional vector to obtain the vector of the joint feature of each joint in the current sub-image.

In an embodiment, the acquiring the occlusion probability of the joint of the corresponding person in each to-be-reasoned sub-image includes:
inputting the vector of the joint feature of each joint in the current sub-image into an occlusion prediction network to obtain the occlusion probability of each joint in the current sub-image outputted by the occlusion prediction network, wherein the occlusion prediction network is obtained by pre-training based on a vector of a joint feature that is known to be occluded or not.

In an embodiment, the occlusion prediction network is composed of a fully connected layer and a sigmoid activation function layer.

In an embodiment, the performing correction based on the joint feature and prediction feature of the joint of the corresponding person in each to-be-reasoned sub-image to obtain the correction feature of the joint of the corresponding person in each to-be-reasoned sub-image includes:
taking an arbitrary to-be-reasoned sub-image as the current sub-image, determining a prediction feature of an arbitrary joint as the corresponding correction feature in response to an occlusion probability of the arbitrary joint in the current sub-image being not less than an occlusion threshold, and otherwise, determining a joint feature of the arbitrary joint as the corresponding correction feature.

In an embodiment, the performing target detection on the to-be-reasoned image to obtain the corresponding target detection result includes:
performing feature extraction on the to-be-reasoned image by using a target detection network to obtain the detection bounding box including each person in the to-be-reasoned image and the target detection result corresponding to each detection bounding box.

In an embodiment, the performing person intention reasoning by using the target detection result and the correction feature of the joint of the corresponding person in each to-be-reasoned sub-image to obtain the corresponding person intention reasoning result includes:
inputting features of other entities, except the person, in the target detection result and the correction feature of the joint of the corresponding person in each to-be-reasoned sub-image into an intention prediction network to obtain the corresponding person intention reasoning result outputted by the intention prediction network.

In an embodiment, the method further includes:
storing the features of other entities, except the person, in the to-be-reasoned image included in the target detection result to a feature access module.

In an embodiment, the method further includes:
storing the prediction feature to a feature access module.

The storing the prediction feature to a feature access module includes:
reading a joint feature f1 of a corresponding joint in the feature access module;
acquiring an occlusion probability p of the joint feature f1; and
in response to the occlusion probability p being less than an occlusion threshold th, pushing the joint feature f1 out of the feature access module, and storing the prediction feature to the feature access module.

A person intention reasoning apparatus includes:
a detection module, configured to perform target detection on a to-be-reasoned image to obtain a corresponding target detection result;
an acquisition module, configured to determine a detection bounding box of each person in the to-be-reasoned image based on the target detection result, determine that an image portion corresponding to each detection bounding box in the to-be-reasoned image is a to-be-reasoned sub-image of a corresponding person respectively, and acquire a joint feature and an occlusion probability of a joint of the corresponding person in each to-be-reasoned sub-image;
a correction module, configured to perform prediction and analysis on the joint feature of corresponding joint based on the occlusion probability to obtain a corresponding prediction feature, and perform correction based on the joint feature and prediction feature of the joint of the corresponding person in each to-be-reasoned sub-image to obtain a correction feature of the joint of the corresponding person in each to-be-reasoned sub-image; and
a reasoning module, configured to perform person intention reasoning by using the target detection result and the correction feature of the joint of the corresponding person in each to-be-reasoned sub-image to obtain a corresponding person intention reasoning result.

A person intention reasoning device includes a memory and one or more processors. The memory stores computer-readable instructions, and the computer-readable instructions, when executed by the one or more processors, cause the one or more processors to execute steps of any one of the above person intention reasoning methods.

An embodiment of the present application finally further provides one or more non-volatile computer-readable storage medium storing computer-readable instructions. The computer-readable instructions, when executed by one or more processors, cause the one or more processors to execute steps of any one of the above person intention reasoning methods.

Details of one or more embodiments of the present application are provided in the accompanying drawings and descriptions below. Other features and advantages of the present application become apparent from the specification, the accompanying drawings, and the claims.

### BRIEF DESCRIPTION OF THE DRAWINGS

In order to describe the embodiments of the present application or the technical solutions in the existing art more clearly, drawings required to be used in the embodiments or the illustration of the existing art will be briefly introduced below. Apparently, the drawings in the illustration below are only some embodiments of the present application. Those ordinarily skilled in the art also can obtain other drawings according to the provided drawings without contributing creative work.

FIG. 1 is a schematic diagram of VCR;

FIG. 2 is a schematic diagram of an intention prediction network in a mainstream person intention reasoning solution;

FIG. 3 is a schematic diagram of basic steps of the mainstream person intention reasoning solution;

FIG. 4 is a flow chart of a person intention reasoning method provided by one or more embodiments of the present application;

FIG. 5 is a schematic diagram of positions of person joints in a person intention reasoning method provided by one or more embodiments of the present application;

FIG. 6 is a schematic diagram of a graph convolutional network in a person intention reasoning method provided by one or more embodiments of the present application;

FIG. 7 is a schematic diagram of two methods for encoding and fusing joint features and occlusion probabilities in a person intention reasoning method provided by one or more embodiments of the present application;

FIG. 8 is an architecture diagram of visual feature extraction based on attitude estimation in a person intention reasoning method provided by one or more embodiments of the present application; and

FIG. 9 is a schematic structural diagram of a person intention reasoning apparatus provided by one or more embodiments of the present application.

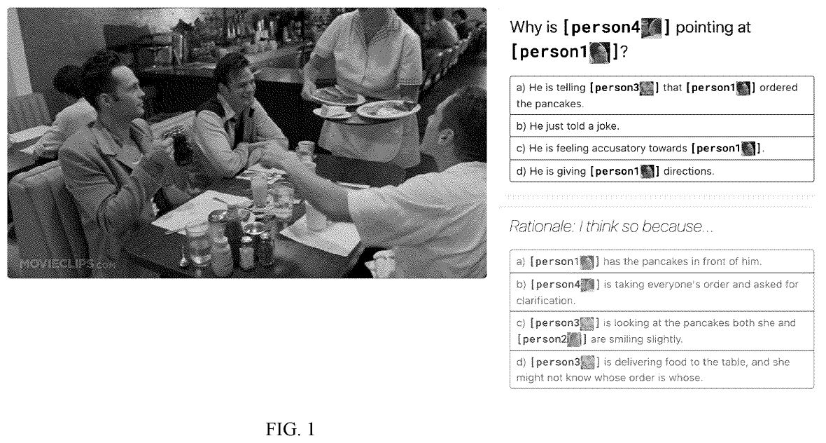

### DETAILED DESCRIPTION

Technical solutions in embodiments of the present application are clearly and completely described in combination with accompanying drawings in embodiments of the present application. Apparently, the described embodiments are merely some embodiments of the present application, not all embodiments. All other embodiments obtained by a person of ordinary skill in the art based on the embodiments of the present application without creative efforts shall fall within the protection scope of the present application.

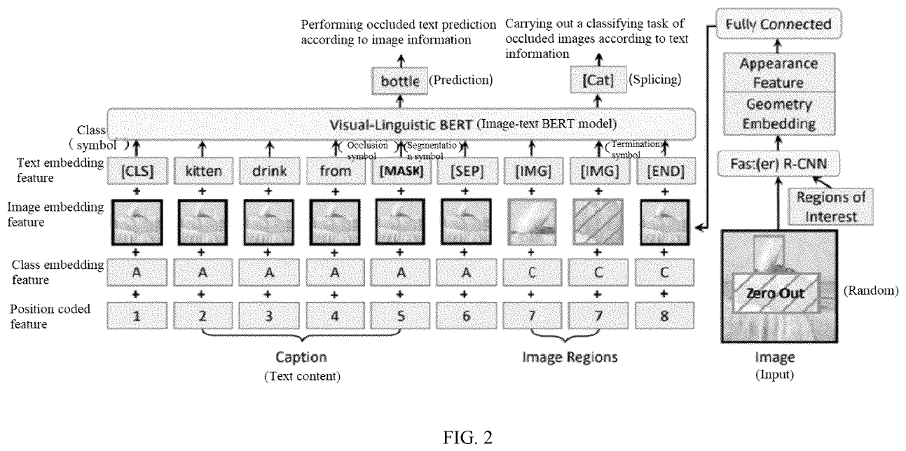

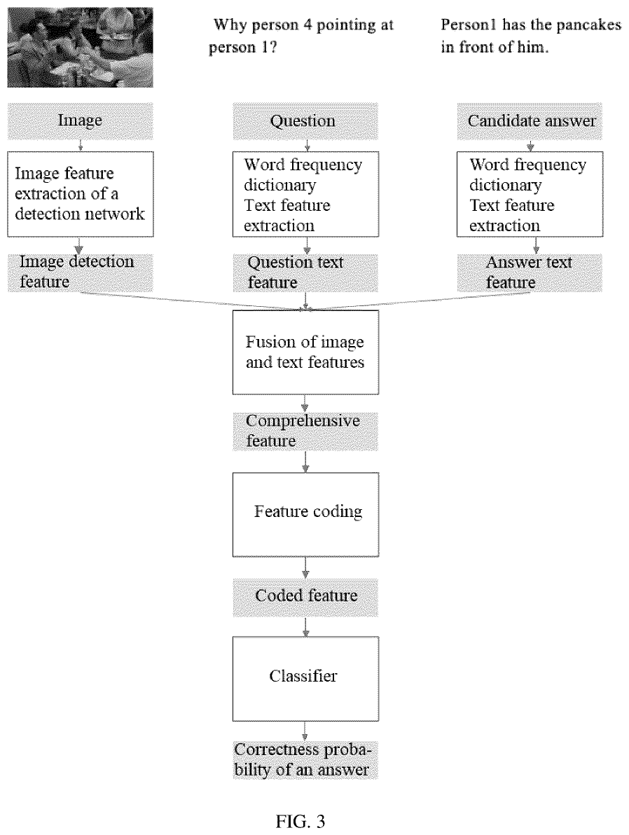

A mainstream method for solving VCR tasks is to input visual features and text features into a transformer structure together to perform modality fusion. On the basis of an intention prediction network (i.e. a multimodal framework VLBERT) as shown in FIG. 2, basic steps of implementing a person intention reasoning solution according to a process shown in FIG. 3 may be as follows:
(1) a target detection dataset such as Visual Genome or COCO is used for training a target detection network (i.e. the detection network in FIG. 3), such as bottom-up and top-down (BUTD);
(2) the trained target detection network is used to perform feature extraction on a current image, which may extract a plurality of target detection bounding boxes (hereinafter abbreviated as detection bounding box) and a feature V∈R^{n×k} (i.e. image detection feature), where, n represents the number of the detection bounding boxes, and k represents a dimensionality of the feature of the detection bounding box;
(3) GLOVE is used to find an embedding vector L∈R^{m×p} for each field of a question text and candidate answer text embedding vectors (the VCR tasks include questions and options), where, m represents a length of a text statement, and p represents a dimensionality of the text embedding vector;
(4) the visual features and the text features L are encoded, and then inputted into a plurality of transformer structures for coding;
(5) the coded features are classified, and a probability that the current answer option may be used as a question answer is judged; and
(6) by replacing different answer options and comparing the final output probability of a model, the option that is most likely used as the question answer is outputted.

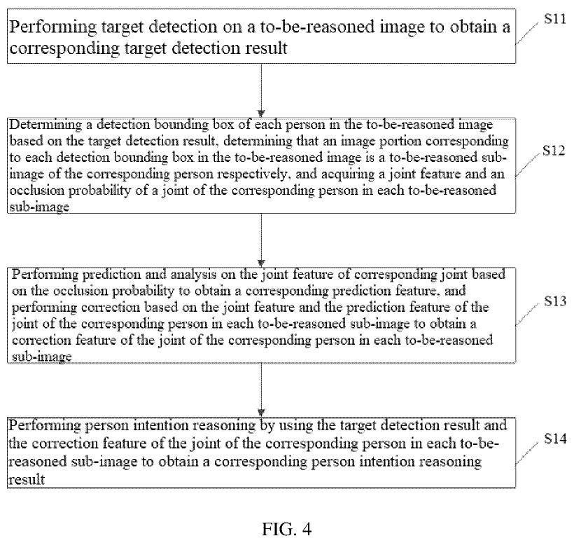

Referring to FIG. 4, FIG. 4 is a flow chart of a person intention reasoning method provided by an embodiment of the present application, which may include:

S11: performing target detection on a to-be-reasoned image to obtain a corresponding target detection result.

The to-be-reasoned image is any image that currently needs the person intention reasoning; and a target detection network is used to perform feature extraction (i.e. target detection) on the to-be-reasoned image, which may obtain the target detection result including each detection bounding box and a feature thereof in the to-be-reasoned image, and a single detection bounding box usually includes a single person.

S12: determining the detection bounding box of each person in the to-be-reasoned image based on the target detection result, determining that an image portion corresponding to each detection bounding box in the to-be-reasoned image is a to-be-reasoned sub-image of the corresponding person respectively, and acquiring a joint feature and an occlusion probability of a joint of the corresponding person in each to-be-reasoned sub-image.

Each detection bounding box and the feature thereof in the to-be-reasoned image may be determined on the basis of the target detection result, it may be subsequently determined that the image portion included by an arbitrary detection bounding box of the detection bounding boxes in the to-be-reasoned image is the to-be-reasoned sub-image of the arbitrary detection bounding box, whereby the to-be-reasoned sub-image corresponding to each detection bounding box in the to-be-reasoned image may be obtained, and the corresponding person intention reasoning may be implemented on the basis of these to-be-reasoned sub-images.

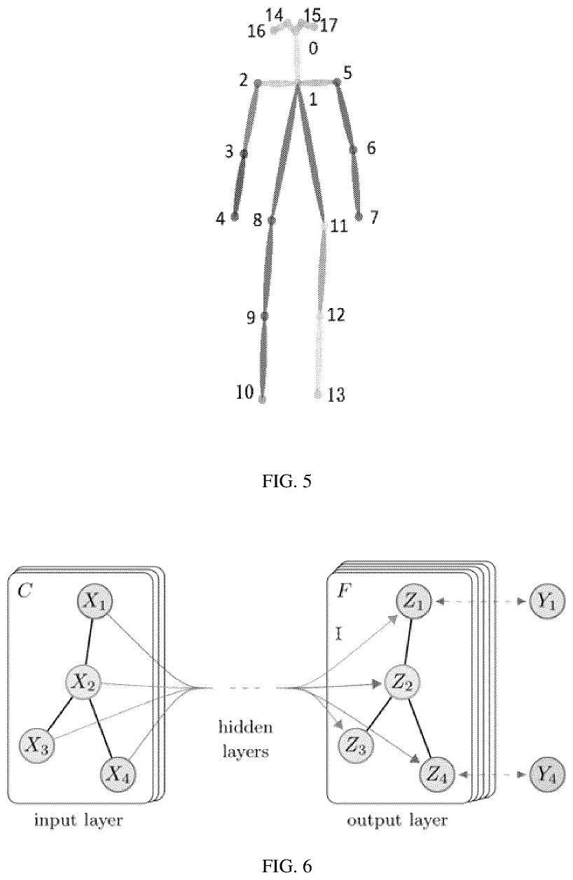

The occlusion probability of an arbitrary joint is the probability that the arbitrary joint is occluded; and for an arbitrary determined to-be-reasoned sub-image, the joint feature and the occlusion probability of the joint of the person included in the arbitrary to-be-reasoned sub-image may be acquired. All joints included in the single person may, as shown in FIG. 5, include 18 joints in total from joint 0 to joint 17, and the intention of the corresponding person may be reasoned effectively on the basis of the features of each joint.

S13: performing prediction and analysis on the joint feature of the corresponding joint based on the occlusion probability to obtain a corresponding prediction feature, and performing correction on the basis of the joint feature and prediction feature of the joint of the corresponding person in each to-be-reasoned sub-image to obtain a correction feature of the joint of the corresponding person in each to-be-reasoned sub-image.

The joint feature of the corresponding joint may be processed on the basis of the occlusion probability of each joint in an arbitrary to-be-reasoned sub-image so as to perform prediction and analysis to obtain the most possible joint feature (called the prediction feature) of the corresponding joint, and the feature of the corresponding joint is corrected on the basis of the joint feature and prediction feature of each joint in the arbitrary to-be-reasoned sub-image so as to obtain the correction feature of each joint in the arbitrary to-be-reasoned sub-image, and the subsequent person intention reasoning is implemented on the basis of the correction feature.

S14: performing the person intention reasoning by using the target detection result and the correction feature of the joint of the corresponding person in each to-be-reasoned sub-image to obtain a corresponding person intention reasoning result.

After the target detection network is used to detect a to-be-reasoned network, the obtained target detection result may also include features of other entities, except the person, in the to-be-reasoned image; and correspondingly, after the correction feature of the joint of the corresponding person in each to-be-reasoned sub-image is obtained, an intention prediction network as shown in FIG. 2 may be called on the basis of the features of other entities, except the person, in the target detection result and the correction feature of the joint of the corresponding person in each to-be-reasoned sub-image, and the corresponding person intention reasoning may be performed according to step (11) to step (14) in basic steps of the person intention reasoning solution.

In the present application, the target detection is performed on the to-be-reasoned image to obtain the target detection result, the image portion corresponding to each detection bounding box included in the target detection result in the to-be-reasoned image is determined as the to-be-reasoned sub-image respectively, the joint feature and the occlusion probability of each joint of the corresponding person in each to-be-reasoned sub-image are acquired, the joint feature of the corresponding joint is predicted and analyzed on the basis of the occlusion probability to obtain the predicted feature of the corresponding joint as the prediction feature, then the correction is performed on the basis of the joint feature and the prediction feature of each joint to obtain the corresponding correction feature, and finally the person intention reasoning is implemented on the basis of the correction feature and the target detection result. It may be seen that in the present application, after the target detection is performed on the to-be-reasoned image, the joint feature and the occlusion probability are acquired on the basis of the image portion corresponding to each detection bounding box obtained by the target detection, and the joint feature is corrected on the basis of the acquired occlusion probability, thereby realizing the extraction of fine-grained human joint feature, and effectively improving the accuracy of the person intention reasoning.

In a person intention reasoning method provided by an embodiment of the present application, the acquiring a joint feature of a joint of the corresponding person in each to-be-reasoned sub-image includes: taking an arbitrary to-be-reasoned sub-image as a current sub-image, and compressing, by a convolutional neural network, the current sub-image into a multi-dimensional vector: obtaining average pooling of certain data in the multi-dimensional vector of the current sub-image to obtain a vector of the joint feature of each joint in the current sub-image, wherein the multi-dimensional vector includes the certain data obtained by compressing a length and a width of the current sub-image according to a downsampling multiple of the convolutional neural network.

The acquiring an occlusion probability of the joint of the corresponding person in each to-be-reasoned sub-image includes: inputting the vector of the joint feature of each joint in the current sub-image into an occlusion prediction network to obtain the occlusion probability of each joint in the current sub-image outputted by the occlusion prediction network, wherein the occlusion prediction network is obtained by pre-training on the basis of the vector of the joint feature that is already known to be occluded or not.

In an embodiment of the present application, the person feature may be extracted on the basis of a simple joint detection network: each person may be abstracted into a plurality of joints (such as a plurality of joints shown in FIG. 5), and then for the extracted image portion corresponding to each detection bounding box, an arbitrary image portion in each image portion is compressed by the convolutional neural network into a multi-dimensional vector of [h//s, w//s, N], wherein s represents the downsampling multiple of the convolutional neural network, // represents a compression operation using the convolutional neural network, N represents the total number of joints contained in the single person (which may be set according to an actual need, for example, when each person is abstracted into a plurality of joints as shown in FIG. 5, N is 18), h and w represent the length and width (i.e. an image size) of the arbitrary image portion respectively, and h//s and w//s may be both called certain data. After the arbitrary image portion is compressed into the multi-dimensional vector of the corresponding [h//s, w//s, N], the average pooling of preceding two dimensions may be obtained for the multi-dimensional vector (that is, obtaining the average pooling of the certain data; and the average pooling is the same as an implementation principle of the corresponding technical solution in the existing art, which is not repeated herein), and an obtained vector of [d, N] (i.e. the vector of the joint feature) indicates that the feature of N joints in the arbitrary image portion are used as the corresponding joint feature, where, d represents the dimensionality of the joint feature of each joint. The joint feature in the image is extracted in a simple and effective way so as to implement the subsequent person intention reasoning operation.

In an embodiment of the present application, an occlusion prediction network predicting whether the joint is occluded may also be added so as to predict whether each joint in the arbitrary image portion is occluded on the basis of the occlusion prediction network. The vector of the joint feature that is already known to be occluded or not may be used in advance for training to obtain the occlusion prediction network, then the vector [d, N] of the joint feature of the image portion that needs to predict whether the joint is occluded is inputted into the occlusion prediction network to obtain a vector [1, N] outputted by the occlusion prediction network, and each value in the vector [1, N] indicates the probability p that the corresponding joint is occluded, wherein the occlusion prediction network may be composed of a fully connected layer with a size of [d, 1] and a sigmoid activation function layer. Therefore, the occlusion probability is acquired rapidly and accurately on the basis of the occlusion prediction network, so as to facilitate the implementation of the subsequent person intention reasoning operation.

In the person intention reasoning method provided by an embodiment of the present application, the performing prediction and analysis on the joint feature of the corresponding joint on the basis of the occlusion probability to obtain a corresponding prediction feature may include: taking an arbitrary to-be-reasoned sub-image as the current sub-image, and performing coding fusion on the joint feature and the corresponding occlusion probability of each joint in the current sub-image to obtain the corresponding fused feature information; and inputting the fused feature information of the current sub-image into an occluded joint prediction network to obtain the prediction feature of each joint in the current sub-image outputted by the occluded joint prediction network, wherein the occluded joint prediction network is obtained by pre-training on the basis of multiple fused feature information of the known prediction feature.

The performing coding fusion on the joint feature and the corresponding occlusion probability of each joint in the current sub-image to obtain a corresponding fused feature information may include: splicing the joint feature of the current sub-image and the occlusion probability of the current sub-image directly into a corresponding multi-dimensional vector as the fused feature information of the current sub-image.

Or alternatively, the performing coding fusion on the joint feature and the corresponding occlusion probability of each joint in the current sub-image to obtain the corresponding fused feature information may include: extending the occlusion probability of the current sub-image into a d-dimensional sub-probability, and adding the d-dimensional sub-probability to a d-dimensional joint feature of the current sub-image in one-to-one correspondence to obtain the fused feature information of the current sub-image.

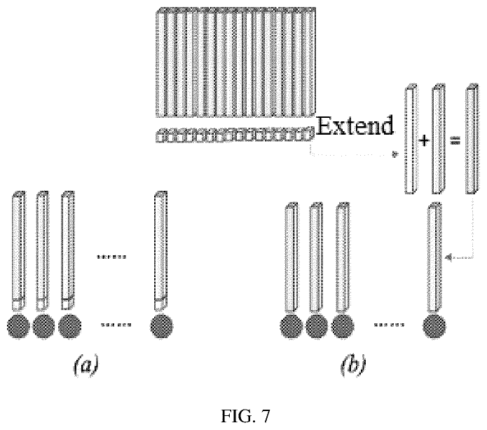

In an embodiment of the present application, a plurality of images may be acquired in advance as training images, and each training image includes a single person; and fused feature information and a corresponding prediction feature of each training image are subsequently obtained, then a graph convolutional network (GCN) is trained on the basis of the fused feature information and corresponding prediction feature of each training image to obtain the occluded joint prediction network so as to rapidly and accurately acquire the corresponding prediction feature of the joint in the corresponding image on the basis of the occluded joint prediction network. The graph convolutional network may be as shown in FIG. 6. It should be noted that in the present application, the graph convolutional network is used to predict the feature of the occluded joint to obtain the corresponding prediction feature, and then an effect of correcting the person feature is achieved on the basis of the prediction feature and the corresponding joint feature. An input form of the graph convolutional network may adopt a coding fusion mode of the joint feature and the occlusion probability, as shown in FIG. 7, including two methods (a) and (b) of coding and fusing the joint feature and the occlusion probability, (a) represents that the d-dimensional joint feature and the one-dimensional occlusion sub-probability p are spliced directly into a (d+1)-dimensional vector, and (b) represents that the occlusion probability p is extended into d dimensions and then added to the joint feature in one-to-one correspondence, whereby any one of the two methods may realize the effective coding of the occlusion information so as to provide a required signal for the graph convolutional network.

In the person intention reasoning method provided by an embodiment of the present application, the performing correction on the basis of the joint feature and the prediction feature of the joint of the corresponding person in each to-be-reasoned sub-image to obtain a correction feature of the joint of the corresponding person in each to-be-reasoned sub-image may include:
taking an arbitrary to-be-reasoned sub-image as the current sub-image, and determining the prediction feature of an arbitrary joint as the corresponding correction feature if the occlusion probability of the arbitrary joint in the current sub-image is not less than an occlusion threshold, and otherwise, determining the joint feature of the arbitrary joint as the corresponding correction feature.

In an embodiment of the present application, a feature access module may be designed to cache the features, the feature access module may be used in three scenarios, including: 1, after the target detection is performed on the to-be-reasoned image, the features of other entities, except the person, in the to-be-reasoned image included in the target detection result are stored in the feature access module: 2, after the prediction feature is obtained, the obtained prediction feature is inputted into the feature access module; and 3, after the prediction feature is obtained, an occluded joint feature is replaced by the corresponding prediction feature, which may use a preset feature replacement gate switch. It may be that a joint feature f1 of the corresponding joint in the feature access module is read, an occlusion probability p indicating whether the joint is occluded is read, and whether a corresponding prediction feature f2 is used for replacement is judged by judging whether p is greater than the occlusion threshold th: if p is less than th, the feature f1 is pushed out, and f2 is stored into an original position; and otherwise, no processing is carried out. Therefore, in a case where the occlusion probability of the arbitrary joint is not less than the occlusion threshold, it means that when the arbitrary joint is likely to be occluded, the prediction feature of the arbitrary joint is remained; otherwise, it means that the probability that the arbitrary joint is occluded is small, so the joint feature of the arbitrary joint is remained, whereby the subsequent person intention reasoning is implemented on the basis of the remained feature, thereby improving the accuracy of the person intention reasoning.

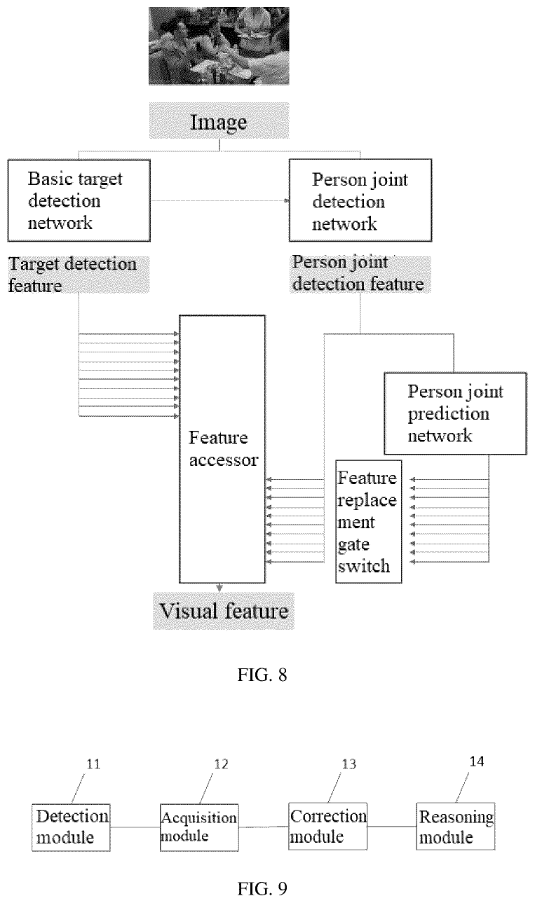

In an implementation, the person intention reasoning method provided by an embodiment of the present application may include two parts: visual feature extraction based on attitude estimation and person intention prediction. The visual feature extraction part based on the attitude estimation may be realized on the basis of an architecture including a basic target detection module (with the same meaning as the basic target detection network), a person joint detection module (with the same meaning as the person joint detection network), a person joint prediction module (with the same meaning as the person joint prediction network), a feature access module (with the same meaning as a feature accessor) and a feature replacement gate switch: the basic target detection module may be, as shown in FIG. 8, configured to implement relevant steps of target detection of the to-be-reasoned image: the person joint detection module is configured to implement relevant steps of acquiring the joint feature and the occlusion probability: the person joint prediction module is configured to implement relevant steps of acquiring the prediction feature: the feature access module is configured to implement relevant steps of caching the corresponding features; and the feature replacement gate switch is configured to implement relevant steps of the replacement between the prediction feature and the joint feature. The person intention prediction part is to extract all features in the feature access module, and the intention prediction network as shown in FIG. 2 is called to repeat the step (11) to step (14) in the basic steps of the person intention reasoning solution.

In the present application, a proportion of the task feature in the multimodal task is increased, fine-grained human joint features are extracted by designing a network used in the person joint detection module and the graph convolutional network to replace the existing coarse-grained visual features, whereby on one hand, the problem of coarse granularity of the person visual features is solved, on the other hand, the problem of feature missing of occluded person parts is solved, the person intention reasoning capacity of a multimodal model is improved, a purpose of more accurately predicting the human intention is achieved, and the accuracy of relevant tasks of the human intension reasoning such as VCR is improved effectively.

An embodiment of the present application further provides a person intention reasoning apparatus, as shown in FIG. 9, which may include:
a detection module 11, configured to perform target detection on a to-be-reasoned image to obtain a corresponding target detection result;
an acquisition module 12, configured to determine a detection bounding box of each person in the to-be-reasoned image according to the target detection result, determine that an image portion corresponding to each detection bounding box in the to-be-reasoned image is a to-be-reasoned sub-image of the corresponding person respectively, and acquire a joint feature and an occlusion probability of a joint of the corresponding person in each to-be-reasoned sub-image;
a correction module 13, configured to perform prediction and analysis on the joint feature of the corresponding joint based on the occlusion probability to obtain a corresponding prediction feature, and perform correction on the basis of the joint feature and the prediction feature of the joint of the corresponding person in each to-be-reasoned sub-image to obtain a correction feature of the joint of the corresponding person in each to-be-reasoned sub-image; and
a reasoning module 14, configured to perform person intention reasoning by using the target detection result and the correction feature of the joint of the corresponding person in each to-be-reasoned sub-image to obtain a corresponding person intention reasoning result.

In the person intention reasoning apparatus provided by an embodiment of the present application, the correction module may include:
a prediction unit, configured to take an arbitrary to-be-reasoned sub-image as a current sub-image, and perform coding fusion on the joint feature and the corresponding occlusion probability of each joint in the current sub-image to obtain the corresponding fused feature information; input the fused feature information of the current sub-image into an occluded joint prediction network to obtain a prediction feature of each joint in the current sub-image outputted by the occluded joint prediction network, wherein the occluded joint prediction network is obtained by pre-training on the basis of multiple pieces of fused feature information of a known prediction feature.

In the person intention reasoning apparatus provided by an embodiment of the present application, the prediction unit may include:
a first splicing unit, configured to splice the joint feature of the current sub-image and the occlusion probability of the current sub-image directly into a corresponding multi-dimensional vector as the fused feature information of the current sub-image.

In the person intention reasoning apparatus provided by an embodiment of the present application, the prediction unit may include:
a second splicing unit, configured to extend the occlusion probability of the current sub-image into a d-dimensional sub-probability, and add the d-dimensional sub-probability to a d-dimensional joint feature of the current sub-image in one-to-one correspondence to obtain fused feature information of the current sub-image.

In the person intention reasoning apparatus provided by an embodiment of the present application, the acquisition module may include:
a first acquisition unit, configured to take an arbitrary to-be-reasoned sub-image as a current sub-image, and compress the current sub-image into a multi-dimensional vector by using a convolutional neural network; and obtain average pooling of specified data in the multi-dimensional vector of the current sub-image to obtain a vector of the joint feature of each joint in the current sub-image, wherein the multi-dimensional vector includes the specified data obtained by compressing a length and a width of the current sub-image according to a downsampling multiple of the convolutional neural network.

In the person intention reasoning apparatus provided by an embodiment of the present application, the acquisition module may include:
a second acquisition unit, configured to input the vector of the joint feature of each joint in the current sub-image into the occlusion prediction network to obtain an occlusion probability of each joint in the current sub-image outputted by the occlusion prediction network, wherein the occlusion prediction network is obtained by pre-training on the basis of the vector of joint feature that is known to be occluded or not.

In the person intention reasoning apparatus provided by an embodiment of the present application, the correction module may include:
a correction unit, configured to take an arbitrary to-be-reasoned sub-image as a current sub-image, and determine the prediction feature of an arbitrary joint as the corresponding correction feature if the occlusion probability of the arbitrary joint in the current sub-image is not less than an occlusion threshold, and otherwise, determine the joint feature of the arbitrary joint as the corresponding correction feature.

An embodiment of the present application further provides a person intention reasoning device, which may include:
a memory, configured to store computer-readable instructions; and
one or more processors, configured to implement steps of any one of the person intention reasoning methods when executing the computer-readable instructions.

An embodiment of the present application further provides one or more non-volatile computer-readable storage medium storing computer-readable instructions. The computer-readable storage medium stores the computer-readable instructions, and the computer-readable instructions, when executed by one or more processors, cause the one or more processors to implement steps of any one of the above person intention reasoning methods.

It should be noted that for descriptions of relevant parts in the person intention reasoning apparatus and device and storage medium provided in the embodiments of the present application, please refer to detailed descriptions of the corresponding parts in the person intention reasoning method provided in the embodiments of the present application, which is not repeated herein. In addition, the parts in the above technical solutions that are consistent with the implementation principle of the corresponding technical solutions in the prior art are not described in detail to avoid repetition.

The above description of the disclosed embodiments enables those skilled in the art to implement or use the present application. Various modifications to these embodiments are apparent for those skilled in the art. The general principles defined herein may be implemented in other embodiments without departing from the spirit or scope of the present application. Therefore, the present application may not be limited to these embodiments described herein, but shall conform to the widest scope consistent with the principles and novel characteristics disclosed herein.

1. A person intention reasoning method, comprising:
performing target detection on a to-be-reasoned image to obtain a corresponding target detection result;
determining a detection bounding box of each person in the to-be-reasoned image based on the target detection result, determining that an image portion corresponding to each detection bounding box in the to-be-reasoned image is a to-be-reasoned sub-image of a corresponding person respectively, and acquiring a joint feature and an occlusion probability of a joint of the corresponding person in each to-be-reasoned sub-image;
performing prediction and analysis on the joint feature of corresponding joint based on the occlusion probability to obtain a corresponding prediction feature, and performing correction based on the joint feature and the corresponding prediction feature of the corresponding joint of the corresponding person in each to-be-reasoned sub-image to obtain a correction feature of the corresponding joint of the corresponding person in each to-be-reasoned sub-image; and
performing person intention reasoning by using the target detection result and the correction feature of the corresponding joint of the corresponding person in each to-be-reasoned sub-image to obtain a corresponding person intention reasoning result.

2. The method according to claim 1, wherein the performing prediction and analysis on the joint feature of the corresponding joint based on the occlusion probability to obtain the corresponding prediction feature comprises:
taking an arbitrary to-be-reasoned sub-image as a current sub-image, and performing coding fusion on the joint feature and corresponding occlusion probability of each joint in the current sub-image to obtain corresponding fused feature information; and
inputting the corresponding fused feature information of the current sub-image into an occluded joint prediction network to obtain a prediction feature of each joint in the current sub-image outputted by the occluded joint prediction network, wherein the occluded joint prediction network is obtained by pre-training based on a plurality of pieces of the corresponding fused feature information of a known prediction feature.

3. The method according to claim 2, wherein the performing coding fusion on the joint feature and the corresponding occlusion probability of each joint in the current sub-image to obtain the corresponding fused feature information comprises:
splicing the joint feature of the current sub-image and the corresponding occlusion probability of the current sub-image directly into a corresponding multi-dimensional vector as the corresponding fused feature information of the current sub-image.

4. The method according to claim 2, wherein the performing coding fusion on the joint feature and the corresponding occlusion probability of each joint in the current sub-image to obtain the corresponding fused feature information comprises:
extending the corresponding occlusion probability of the current sub-image into a d-dimensional sub-probability, and adding the d-dimensional sub-probability to a d-dimensional joint feature of the current sub-image in one-to-one correspondence to obtain the corresponding fused feature information of the current sub-image.

5. The method according to claim 4, wherein the adding the d-dimensional sub-probability to the d-dimensional joint feature of the current sub-image in one-to-one correspondence to obtain the corresponding fused feature information of the current sub-image comprises:
splicing the d-dimensional joint feature and one-dimensional occlusion sub-probability into a (d+1)-dimensional vector to obtain the corresponding fused feature information of the current sub-image.

6. The method according to claim 4, wherein the adding the d-dimensional sub-probability to the d-dimensional joint feature of the current sub-image in one-to-one correspondence to obtain the corresponding fused feature information of the current sub-image comprises:
extending occlusion sub-probability into d dimensions, and then adding to the d-dimensional joint feature of the current sub-image in one-to-one correspondence to obtain the corresponding fused feature information of the current sub-image.

7. The method according to claim 2, wherein the method further comprises:
acquiring a plurality of images as training images respectively, wherein each of the training images comprises a single person;
acquiring fused feature information and a corresponding prediction feature of each of the training images; and
inputting the fused feature information and the corresponding prediction feature of each of the training images into a graph convolutional network, and training the graph convolutional network to obtain a trained graph convolutional network, wherein the trained graph convolutional network is the occluded joint prediction network.

8. The method according to claim 1, wherein the acquiring the joint feature of the joint of the corresponding person in each to-be-reasoned sub-image comprises:
taking an arbitrary to-be-reasoned sub-image as a current sub-image, and compressing the current sub-image into a multi-dimensional vector by using a convolutional neural network, wherein the multi-dimensional vector comprises specified data obtained by compressing a length and a width of the current sub-image respectively according to a downsampling multiple of the convolutional neural network; and
obtaining average pooling of the specified data in the multi-dimensional vector of the current sub-image to obtain a vector of the joint feature of each joint in the current sub-image.

9. The method according to claim 8, wherein the compressing the current sub-image into the multi-dimensional vector by using the convolutional neural network comprises:
abstracting the current sub-image into a plurality of joints, and for an extracted image portion of the current sub-image corresponding to each detection bounding box, compressing, by the convolutional neural network, an arbitrary image portion in each extracted image portion into a multi-dimensional vector of [h//s, w//s, N],
wherein, s represents the downsampling multiple of the convolutional neural network, // represents a compression operation using the convolutional neural network, N represents a total number of joints contained in the current sub-image, h and w represent a length and a width of the arbitrary image portion respectively, and h//s and w//s are both the specified data.

10. The method according to claim 8, wherein the obtaining average pooling of the specified data in the multi-dimensional vector of the current sub-image to obtain the vector of the joint feature of each joint in the current sub-image comprises:
obtaining average pooling of specified data of preceding two dimensional vectors in the multi-dimensional vector to obtain the vector of the joint feature of each joint in the current sub-image.

11. The method according to claim 8, wherein the acquiring the occlusion probability of the joint of the corresponding person in each to-be-reasoned sub-image comprises:
inputting the vector of the joint feature of each joint in the current sub-image into an occlusion prediction network to obtain the occlusion probability of each joint in the current sub-image outputted by the occlusion prediction network, wherein the occlusion prediction network is obtained by pre-training based on a vector of a joint feature that is known to be occluded or not.

12. The method according to claim 11, wherein the occlusion prediction network is composed of a fully connected layer and a sigmoid activation function layer.

13. The method according to claim 1, wherein the performing correction based on the joint feature and the corresponding prediction feature of the corresponding joint of the corresponding person in each to-be-reasoned sub-image to obtain the correction feature of the corresponding joint of the corresponding person in each to-be-reasoned sub-image comprises:
taking an arbitrary to-be-reasoned sub-image as a current sub-image, determining a prediction feature of an arbitrary joint as the correction feature in response to an occlusion probability of the arbitrary joint in the current sub-image being not less than an occlusion threshold, and in response to the occlusion probability of the arbitrary joint in the current sub-image being less than the occlusion threshold, determining a joint feature of the arbitrary joint as the correction feature.

14. The method according to claim 1, wherein the performing target detection on the to-be-reasoned image to obtain the corresponding target detection result comprises:
performing feature extraction on the to-be-reasoned image by using a target detection network to obtain the detection bounding box comprising each person in the to-be-reasoned image and the target detection result corresponding to each detection bounding box.

15. The method according to claim 1, wherein the performing person intention reasoning by using the target detection result and the correction feature of the corresponding joint of the corresponding person in each to-be-reasoned sub-image to obtain the corresponding person intention reasoning result comprises:
inputting features of other entities, except the corresponding person, in the target detection result and the correction feature of the corresponding joint of the corresponding person in each to-be-reasoned sub-image into an intention prediction network to obtain the corresponding person intention reasoning result outputted by the intention prediction network.

16. The method according to claim 15, wherein the method further comprises:
storing the features of other entities, except the corresponding person, in the to-be-reasoned image comprised in the target detection result to a feature access module.

17. The method according to claim 15, wherein the method further comprises:
storing the corresponding prediction feature to a feature access module,
wherein the storing the corresponding prediction feature to the feature access module comprises:
reading the joint feature of the corresponding joint in the feature access module;
acquiring an occlusion probability of the joint feature; and
in response to the occlusion probability of the joint feature being less than an occlusion threshold, pushing the joint feature out of the feature access module, and storing the corresponding prediction feature to the feature access module.

18. (canceled)

19. A person intention reasoning device, comprising a memory and one or more processors, wherein the memory stores computer-readable instructions, and the computer-readable instructions, upon execution by the one or more processors, is configured to cause the one or more processors to:
perform target detection on a to-be-reasoned image to obtain a corresponding target detection result;
determine a detection bounding box of each person in the to-be-reasoned image based on the target detection result, determine that an image portion corresponding to each detection bounding box in the to-be-reasoned image is a to-be-reasoned sub-image of a corresponding person respectively, and acquire a joint feature and an occlusion probability of a joint of the corresponding person in each to-be-reasoned sub-image;
perform prediction and analysis on the joint feature of corresponding joint based on the occlusion probability to obtain a corresponding prediction feature, and perform correction based on the joint feature and the corresponding prediction feature of the corresponding joint of the corresponding person in each to-be-reasoned sub-image to obtain a correction feature of the corresponding joint of the corresponding person in each to-be-reasoned sub-image; and
perform person intention reasoning by using the target detection result and the correction feature of the corresponding joint of the corresponding person in each to-be-reasoned sub-image to obtain a corresponding person intention reasoning result.

20. One or more non-volatile computer-readable storage medium, storing computer-readable instructions, wherein the computer-readable instructions, upon execution by one or more processors, is configured to:
perform target detection on a to-be-reasoned image to obtain a corresponding target detection result;
determine a detection bounding box of each person in the to-be-reasoned image based on the target detection result, determine that an image portion corresponding to each detection bounding box in the to-be-reasoned image is a to-be-reasoned sub-image of a corresponding person respectively, and acquire a joint feature and an occlusion probability of a joint of the corresponding person in each to-be-reasoned sub-image;
perform prediction and analysis on the joint feature of corresponding joint based on the occlusion probability to obtain a corresponding prediction feature, and perform correction based on the joint feature and the corresponding prediction feature of the corresponding joint of the corresponding person in each to-be-reasoned sub-image to obtain a correction feature of the corresponding joint of the corresponding person in each to-be-reasoned sub-image; and
perform person intention reasoning by using the target detection result and the correction feature of the corresponding joint of the corresponding person in each to-be-reasoned sub-image to obtain a corresponding person intention reasoning result.

21. The method according to claim 14, wherein the target detection network is trained by Visual Genome (VG) or Common Objects in Context (COCO).
